(19) United States
(12) Patent Application Publication
(10) Pub. No.: US 2008/0036905 A1
(43) Pub. Date: Feb. 14, 2008

(54) Display rotation apparatus and method of joining the display rotation apparatus to a display

(75) Inventors: Yang-Ho Moon, Ansan-si (KR); Chil-Sung Lee, Suwon-si (KR); Kyoung-Shin Park, Suwon-si (KR); Dong-Won Choi, Suwon-si (KR); Jae-Kyung Kim, Ansan-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/812,671

(22) Filed: Jun. 20, 2007

(30) Foreign Application Priority Data
Jun. 20, 2006 (KR) 10-2006-0055254

(51) Int. Cl. H04N 5/225

(52) U.S. Cl. 348/373; 348/E05.024

(57) ABSTRACT

A display rotation apparatus and a method of joining the display rotation apparatus with a display. The display rotation apparatus, which includes a fixed body, an arm part having one end joined to the fixed body, a hinge member joined to the other end of the arm part, and a guide member rotatably joined to the hinge member, can adjust the joining point according to the center of mass of the display.

### CROSS-REFERENCE TO RELATED APPLICATIONS

This application claims the benefit of Korean Patent Application No. 10-2006-0055254 filed with the Korean Intellectual Property Office on Jun. 20, 2006, the disclosure of which is incorporated herein by reference in its entirety.

### BACKGROUND

1. Technical Field

The present invention relates to a display rotation apparatus and a method of joining the display rotation apparatus to a display.

2. Description of the Related Art

Flat panel displays, such as TV's or monitors employing LCD's, PDP's, LED's, etc., provide the benefit of allowing efficient use of spaces, and are fast replacing Braun tube TV's and monitors. The increase in demand for such flat panel displays is expected to continue into the future. In particular, flat panel LCD or PDP TV's, often referred to as “wall-mount TV's,” are fixedly attached to wall surfaces for use. When viewing a wall-mount TV thus fixed, the largest viewing angle is achieved directly in front of the TV.

However, when the TV is fixed to a wall surface, the position that allows the largest viewing angle of the TV screen is also fixed, and as a viewer changes position, adequate viewing may not be obtained.

### SUMMARY

An aspect of the claimed invention is to provide is to provide an apparatus and method for rotating a display to ensure a required viewing angle. Also, an aspect of the invention is to provide an apparatus and method for rotating a display with a low-power motor.

One aspect of the claimed invention provides a display rotation apparatus that includes a fixed body, an arm part having one end joined to the fixed body, a hinge member joined to the other end of the arm part, and a guide member rotatably joined to the hinge member.

A display may be joined to the guide member and the joining point between the guide member and the display may be adjustable in correspondence to the gravitational moment of the hinge member about the center of rotation. That is, the display may be joined in variable positions by the guide member.

Also, an elastic member, which exerts an elastic force resisting the gravitational moment, may be interposed between the arm part and the display.

A desirable joining point between the display and the guide member may be the point that makes an imaginary rotation line, which links the center of rotation and the center of mass, have a prescribed rotation angle from a line perpendicular to gravity in an opposite direction to gravity, if the display is capable of rotation in a prescribed rotation angle about the center of rotation of the hinge member in the direction of gravity while the display is joined to the guide member parallel to gravity.

The guide member may include a protrusion joined to the display and a guide rail joined to the protrusion and joined to the hinge member.

Another aspect of the claimed invention provides a method of joining a display and a display rotation apparatus which includes an arm part and a hinge member joined to one end of the arm part. The method includes determining a center of rotation of the hinge member and a center of mass of the display, and joining the display rotation apparatus with the display to position the center of mass above a line perpendicular to gravity that passes the center of rotation.

A desirable method for joining the display rotation apparatus with the display may be to join at a position where an imaginary rotation line, linking the center of rotation of the hinge member and the center of mass of the display, is made to have the prescribed rotation angle from a line perpendicular to gravity and in an opposite direction to gravity.

Additional aspects and advantages of the invention will be set forth in part in the description which follows, and in part will be obvious from the description, or may be learned by practice of the invention.

### BRIEF DESCRIPTION OF THE DRAWINGS

FIG. 1 is a side elevational view and a partially magnified view of a display rotation apparatus according to a first disclosed embodiment of the invention.

FIG. 2 is a graph illustrating profiles of the weight moment of the display, the moment of the elastic member, and the required torque of the motor according to the first disclosed embodiment of the invention.

FIG. 3 is a side elevational view of a display rotation apparatus according to a second disclosed embodiment of the invention.

FIG. 4 is a graph illustrating profiles of the weight moment of the display, the moment of the elastic member, and the required torque of the motor according to the second disclosed embodiment of the invention.

FIG. 5 is a perspective view of a display rotation apparatus according to a third disclosed embodiment of the invention.

FIG. 6 is a flow chart of a method of joining a display rotation apparatus with a display according to a fourth disclosed embodiment of the invention.

### DETAILED DESCRIPTION

Embodiments of the display rotation apparatus and the method of joining the display rotation apparatus to a display according to certain aspects of the invention will be described below in more detail with reference to the accompanying drawings. In the description with reference to the accompanying drawings, those components are rendered the same reference number that are the same or are in correspondence regardless of the figure number, and redundant explanations are omitted.

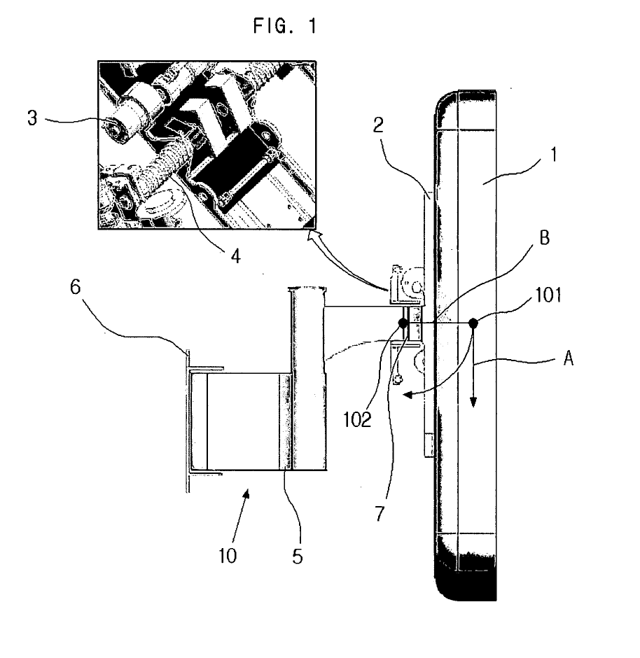

FIG. 1 is a side elevational view and a partially magnified view of a display rotation apparatus according to a first disclosed embodiment of the invention. In FIG. I are illustrated a display 1, a guide member 2, a motor part 3, an elastic member 4, an arm part 5, a fixed body 6, a hinge member 7, a center of mass 101, a center of rotation 102, and a display rotation apparatus 10.

As in FIG. 1, the display 1 may be protruded from the wall by the rotation of the arm part 5. One end of the arm part 5 may be joined to the fixed body 6, while the other end may be joined to the hinge member 7. The joining point of the display 1 may be adjusted by the guide member 2 joined to the hinge member 7. Also, to prevent drooping of the display 1 by gravity, the elastic member 4 may be joined to exert a moment that resists the gravity.

The motor part 3 is a power serving apparatus to rotate the display 1 up, down, left, and right. The power of motor part 3 may overcome the net moment, after summing the weight moment of the display 1 and the moment by the elastic member 4, to rotate the display 1.

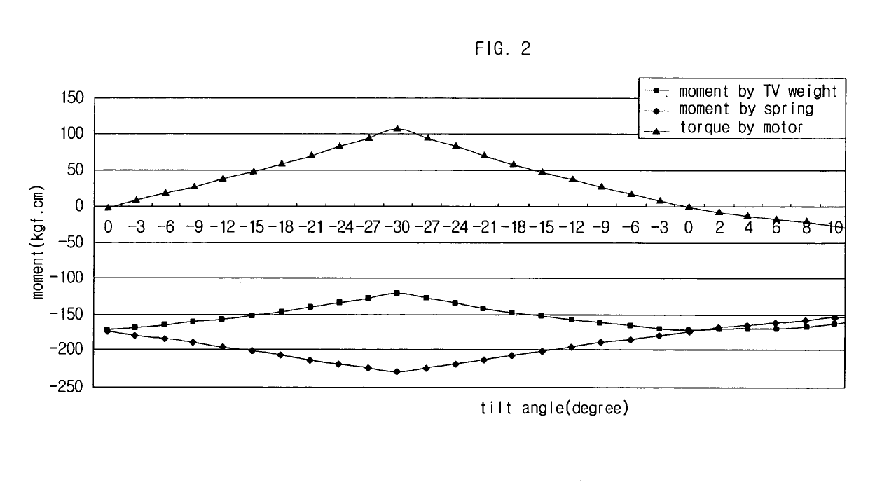

The changes in the weight moment of the display 1, the moment of the elastic member 4, and the required torque of motor to rotate the display 1 are shown in FIG. 2, according to the clockwise (direction of gravity) and counter-clockwise (opposite to the direction of gravity) rotation of the center of mass 101 about the center of rotation 102.

In the description of FIG. 2, the moments in the direction of gravity are denoted with negative signs for convenience. However, the moment of the elastic member 4 in the direction of gravity is denoted with positive signs for easy comparison with the moment of the display 1. Also, the rotation of the center of mass 101 about the center of rotation 102 is denoted with negative rotation angles when it rotates clockwise (direction of gravity) and denoted with positive rotation angles when it rotates counter-clockwise (opposite to the direction of gravity).

A description will now be given of the moment of the elastic member, the weight moment of the display, and the required torque of the motor to rotate the display, according to the rotation of the center of mass 101 of the display 1 in FIG. 1.

When the center of mass 101 is rotated 30 degrees clockwise, the absolute value of the weight moment of the display 1 is decreased. That is, if θ represents the rotation angle of the center of mass 101 from a line B perpendicular to gravity, the weight moment of the display is proportional to cos θ. As in FIG. 2, as the center of mass 101 rotates clockwise, the absolute value of the weight moment of the display 1 decreases, and the maximum absolute value is obtained at the start point, 0 degrees. However, the absolute value of the moment of the elastic member 4 increases as the center of mass 101 rotates clockwise, because the spring is wound when a coil type spring is used as -in FIG. 1. In the case of rotating counter-clockwise, in the loosening direction, the absolute value of the moment of the elastic member 4 decreases.

When the torque of motor is larger than the difference between the absolute value of the moment applied by the elastic member 4 and the absolute value of the weight moment applied by the display 1, the motor may be capable of rotating the display 1. Consequently, a motor may be used that can output a torque that is in correspondence to the maximum value in FIG. 2.

Because the weight of a display such as a flat panel TV may be several tens of kilograms, it may be difficult to control the rotation of the display 1 with a small motor. A description is provided below on a desirable position for joining the display rotation apparatus with the display.

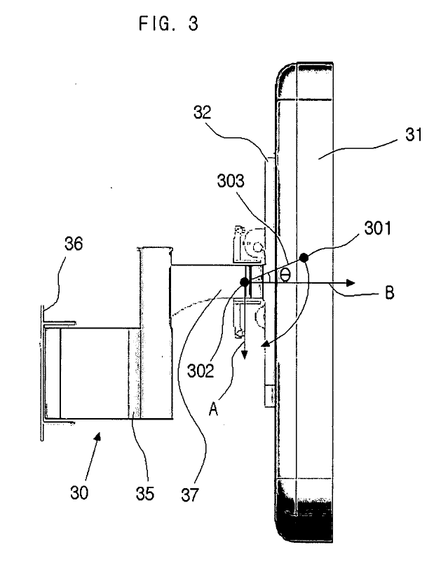

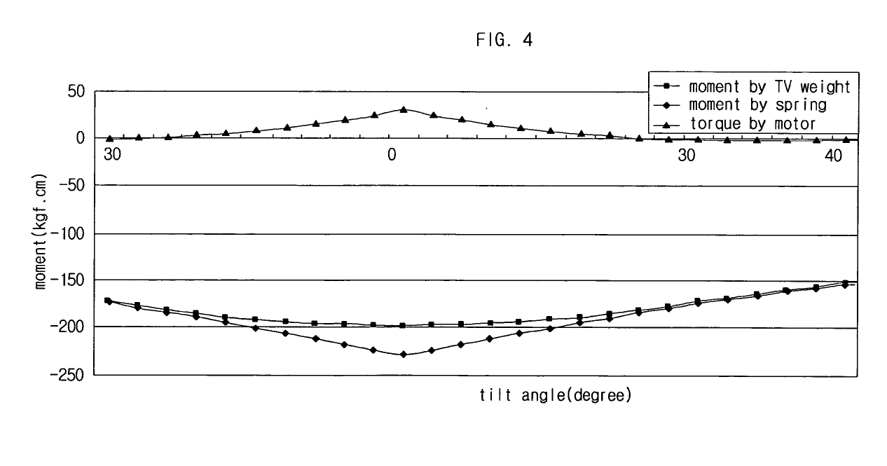

FIG. 3 is a side elevational view of a display rotation apparatus according to a second disclosed embodiment of the invention. FIG. 4 is a graph illustrating profiles of the weight moment of the display, the moment of the elastic member, and the required torque of the motor according to the second disclosed embodiment of the invention. In FIG. 3 are illustrated a display 31, a guide member 32, an arm part 35, a fixed body 36, a hinge member 37, a center of mass 301, a center of rotation 302, a rotation line 303, and a display rotation apparatus 30.

As in FIG. 3, one end of the arm part 35 in the display rotation apparatus 30 may be joined to the display 31, with the hinge member 37 and the guide member 32 interposed. The hinge member 37 may be directly joined to the display 31 without the guide member 32.

When the display 31 is arranged parallel to the direction of gravity A, the point at which the display rotation apparatus 30 is to be joined with the display 31 may be a particular point of the display 31 that makes the rotation line 303, which links the center of rotation 302 and the center of mass 301, have a predetermined rotation angle θ from a line B perpendicular to gravity, which passes the center of rotation 302, in a direction opposite to the direction of gravity. Consequently, as in FIG. 3, the center of mass 301 is positioned above the line B perpendicular to gravity. The term ‘above’ refers to a direction opposite to the direction of gravity from the line B perpendicular to the direction of gravity. Here, only the up-down joining position is illustrated, because FIG. 3 is a side elevational view. The left-right joining position may be a particular point that corresponds to the straight line that passes the center of mass 301.

Meanwhile, the ‘rotation angle θ’ means the maximum angle of clockwise (direction of gravity) rotation of the rotation line 303 that links the center of mass 301 and the center of rotation 302, when the display 31 is joined to the display rotation apparatus 30 in an orientation parallel to gravity. The rotation angle can be varied according to the desired angle. When the display 31 is attached at a high position, a larger rotation angle may be required, as a viewer is in a lower position than the display 31. In this embodiment, the rotation angle is set to 30 degrees.

FIG. 4 is a graph illustrating profiles of the weight moment of the display, the moment of the elastic member, and the required torque of the motor, measured at the center of rotation 302 according to the rotation of the display 31, in this embodiment of the invention. In FIG. 4, the weight moment of the display in the direction of gravity is denoted with negative signs. However, for the moment of the elastic member, the direction opposite to the direction of gravity is denoted with negative signs for easy comparison between the two moments.

Describing FIG. 4 in detail, the display 31 is rotated clockwise from the point where the rotation line 303 that links the center of rotation 302 and the center of mass 301 is +30 degrees from the line B perpendicular to gravity. In this case, as in FIG. 4, the absolute value of the weight moment of the display is increased to reach the maximum at 0 degrees. This is because the more the center of mass 301 of the display 31 is drawn apart from the center of rotation 302 horizontally (in a direction perpendicular to gravity), the more the absolute value is increased. In other words, the weight moment of the display 31 is proportional to cos θ. Consequently, as in FIG. 4, the weight moment of the display 31 has a maximum at 0 degrees. Then, as the display 31 rotates to +30 degree counter-clockwise (opposite to gravity), the absolute value of the weight moment of the display 31 is decreased.

Conversely, when the display 31 rotates clockwise, the elastic force exerted by the coil type elastic member 4 in FIG. 1 increases as the coil is wound, because the moment of the elastic member is denoted with negative signs when rotating counter-clockwise. The moment is increased the more the display 31 rotates clockwise and is decreased the more the display 31 rotates counter-clockwise. Consequently, the moment applied by the elastic member has a maximum at 0 degrees, as in FIG. 4.

The weight moment of the display and the moment of the elastic member are in opposite directions, and the display can be rotated when the motor overcomes the net moment. The required torque of the motor to overcome the net moment is the difference between the absolute value of the weight moment applied by the display and the absolute value of the moment applied by the elastic member, as in FIG. 4. Compared to the required torque of the motor in FIG. 2 according to the first disclosed embodiment, the required torque of the motor in FIG. 4 is smaller. This means that the required torque of the motor can be reduced by adjusting the position at which the display rotation apparatus 30 is joined with the display 31 to obtain a profile for the weight moment applied by the display according to the rotation of the display 31 that is close to that of the moment applied by the elastic member.

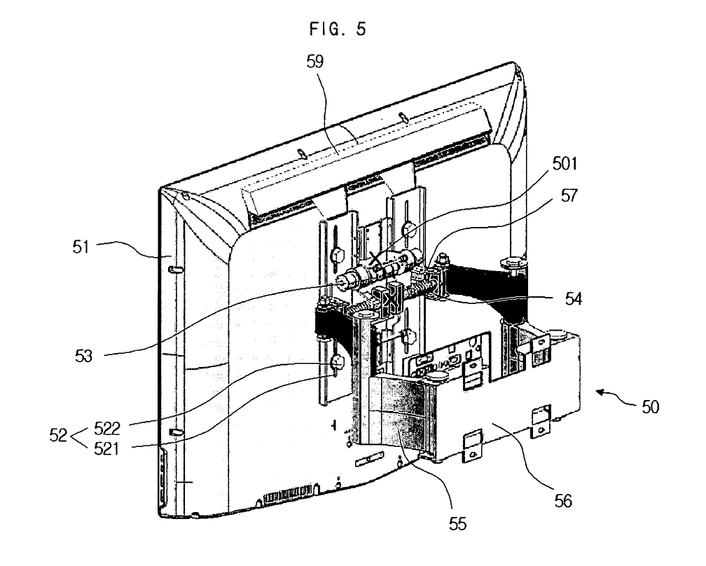

FIG. 5 is a perspective view of display rotation apparatus according to a third disclosed embodiment of the invention. In FIG. 5 are illustrated a display 51, guide members 52, guide rails 521, protrusions 522, a motor part 53, elastic members 54, arm parts 55, a display rotation apparatus 50, a fixed body 56, hinge members 57, and a weight 59.

As in FIG. 5, the display rotation apparatus 50 may include the arm part 55. One end of the arm part 55 may be fixed to the fixed body 56 and the other end of the arm part 55 may be joined to the hinge member 57. The hinge member 57 may be joined to the back side of the display 51 with the guide member 52 interposed. The structure of the display rotation apparatus 50 in this embodiment allows the functions of extending and contracting with respect to the fixed body 56, but the extension and contraction functions may be omitted.

The guide member 52 may be composed of the protrusion 522 joined to the display 51 and the guide rail 521 joined to the hinge member 57. The protrusion 522 may be fixed to a particular point on the guide rail 521.

As noted above, the reason for allowing variability in the point at which the display rotation apparatus 50 may be joined with the display 51 is due to the variability of the type of display. The center of mass 501 may also be modified easily with the weight 57 joined to the display 51.

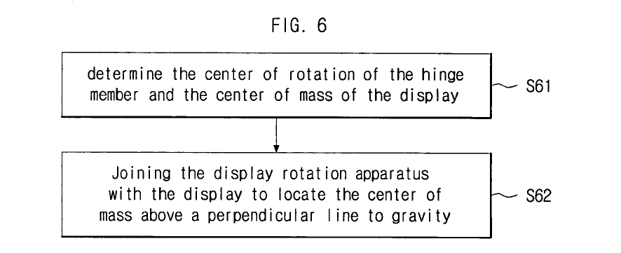

A method of joining a display rotation apparatus with a display is described below with reference to the elements of the embodiment shown in FIG. 3. FIG. 6 is a flow chart of a method of joining a display rotation apparatus with a display according to a fourth disclosed embodiment of the invention.

Operation S61 of FIG. 6 is that of determining the center of rotation 302 of the hinge member 37 and the center of mass 301 of the display 31. Because the center of rotation 302 and the center of mass 301 are important elements in determining the joining point of the display 31, the position of these may be determined before joining the display rotation apparatus 30 with the display 31.

Operation S62 of FIG. 6 is that of joining the hinge member 37 with the display 31 to position the center of mass 301 above a line B perpendicular to gravity. As in FIG. 3, the center of mass 301 of the display 31 may be positioned above the line B perpendicular to gravity, which passes through the center of rotation 302, i.e. opposite to gravity. It may not be helpful to position the center of mass 301 below the line B perpendicular to gravity, because the required torque of the motor may be increased. Here, the display 31 may be arranged parallel to the direction of gravity A.

A possible joining point is described below. When the center of rotation 302 and the center of mass 301 are determined, the rotation angle in the direction of gravity A may be determined, while the display 31 is joined to the hinge member 37 to be parallel to the direction of gravity A. The meaning of the rotation angle has been described sufficiently with regard the first embodiment, and thus the details are omitted.

After the rotation angle is determined, the display 31 may be joined with the hinge member 37 such that an imaginary rotation line 303, which links the center of rotation 302 and the center of mass 301, is made to have a rotation angle from the line B perpendicular to gravity, which passes through the center of rotation 302, in a direction opposite to gravity. The display 31 may be joined after the display 31 is arranged to be parallel to gravity. When the rotation angle of the display 31 and the angle between the rotation line 303 and the line B perpendicular to gravity are the same, as in FIG. 3, the profile of the gravitational moment applied by the display and that of the moment applied by the elastic member become similar, as in FIG. 4, and consequently the torque of the motor can be minimized.

According to certain embodiments of the invention as set forth above, a rotation apparatus may be joined with a display to minimize the torque of the motor. Also, various displays may be joined because the joining point may easily be varied.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A display rotation apparatus comprising:
a fixed body;
an arm part having one end joined to the fixed body;
a hinge member joined to the other end of the arm part; and
a guide member rotatably joined to the hinge member.

2. The display rotation apparatus of claim 1, wherein the guide member is joined to a display; and
a joining point between the guide member and the display is adjustable in correspondence to a gravitational moment about a center of rotation of the hinge member.

3. The display rotation apparatus of claim 2, further comprising an elastic member interposed between the arm part and the display,
the elastic member configured to exert an elastic force resisting the gravitational moment.

4. The display rotation apparatus of claim 3, wherein if the display, joined to the guide member to be parallel to a direction of gravity, is capable of rotation by a prescribed rotation angle in a direction of gravity about the center of rotation of the hinge member,
the joining point between the guide member and the display is positioned where an imaginary line that links the center of rotation of the hinge member and a center of mass of the display forms the rotation angle with respect to a line perpendicular to gravity and in an opposite direction to gravity.

5. The display rotation apparatus of claim 3, wherein the guide member comprises:
a protrusion joined to the display; and
a guide rail joined to the protrusion and joined to the hinge member.

6. A method of joining a display with a display rotation apparatus that comprises an arm part and a hinge member joined to one end of the arm part, the method comprising:
determining a center of rotation of the hinge member and a center of mass of the display; and
joining the display rotation apparatus with the display to position the center of mass above a line perpendicular to gravity that passes the center of rotation.

7. The method of claim 6, wherein the joining comprises,
if the display, joined to the guide member to be parallel to a direction of gravity, is capable of rotation by a prescribed rotation angle in a direction of gravity about the center of rotation of the hinge member,
joining the guide member and the display at a position where an imaginary line that links the center of rotation of the hinge member and a center of mass of the display forms the rotation angle with respect to a line perpendicular to gravity and in an opposite direction to gravity.
